(19) United States
(12) Patent Application Publication
(10) Pub. No.: US 2008/0190820 A1
(43) Pub. Date: Aug. 14, 2008

(54) ROTARY SCREENING DEVICE

(76) Inventor: Allan Skoropa, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 11/866,003

(22) Filed: Oct. 2, 2007

Related U.S. Application Data
(60) Provisional application No. 60/888,858, filed on Feb. 8, 2007.

(51) Int. Cl. B07B 1/22

(52) U.S. Cl. 209/288

(57) ABSTRACT

A screening mechanism may include a frame member, a drive mechanism, a bowl, and a screen assembly. The drive mechanism may be coupled to the frame member. The bowl may be rotatably supported on the frame member and may be in driven engagement with the drive mechanism. The screen assembly may be fixed to the bowl for rotation therewith and may include a plurality of panels removably coupled to one another and removably coupled to the bowl.

### CROSS-REFERENCE TO RELATED APPLICATIONS

This application claims the benefit of U.S. Provisional Application No. 60/888,858, filed on Feb. 8, 2007. The disclosure of the above application is incorporated herein by reference.

### FIELD

The present disclosure relates to screening devices, and more specifically to rotationally driven screening devices.

### BACKGROUND

The statements in this section merely provide background information related to the present disclosure and may not constitute prior art.

Material screening typically involves the use of a large vibratory screening machine. Smaller screening tasks are typically accomplished manually. For example, smaller screening jobs may require shoveling material onto a screen and screening the material by hand. Large vibratory screening machines are large and expensive, resulting in the larger machines being impractical for smaller screening jobs. Manual screening is undesirable due to the labor-intensive nature thereof.

### SUMMARY

A screening mechanism may include a frame member, a drive mechanism, a bowl, and a screen assembly. The drive mechanism may be coupled to the frame member. The bowl may be rotatably supported on the frame member and may be in driven engagement with the drive mechanism. The screen assembly may be fixed to the bowl for rotation therewith and may include a plurality of panels removably coupled to one another and removably coupled to the bowl.

The panels may be generally rectangular in shape and may be removably coupled to one another to form a generally polygonal shape.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a rotary screening device according to the present disclosure;

FIG. 2 is an additional perspective view of the rotary screening device of FIG. 1;

FIG. 3 is an additional perspective view of the rotary screening device of FIG. 1;

FIG. 4 is a fragmentary perspective exploded view of a screen assembly of the screening device of FIG. 1; and

FIG. 5 is a perspective view of an alternate rotary screening device according to the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

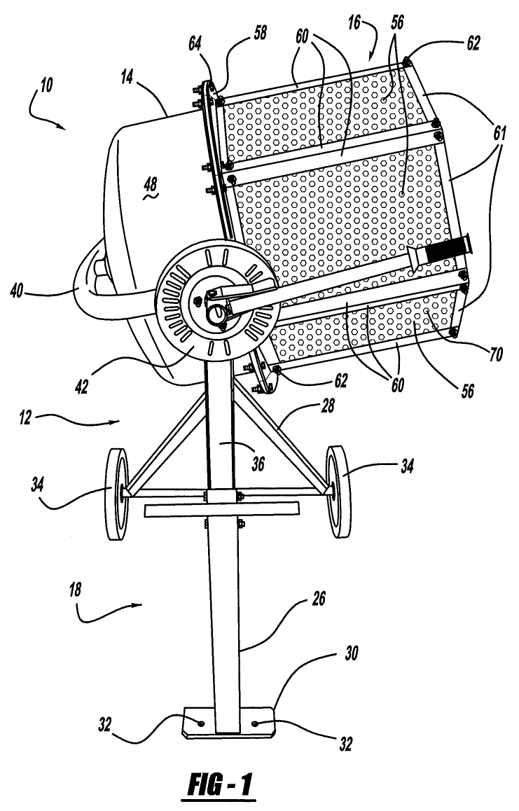

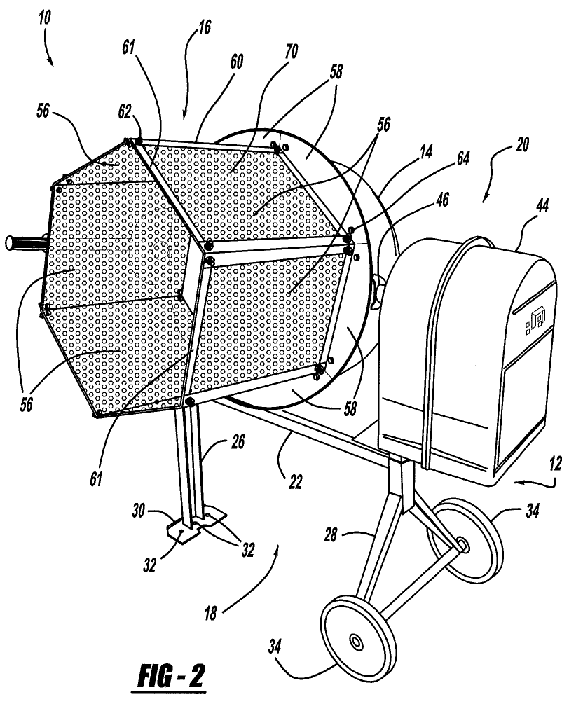

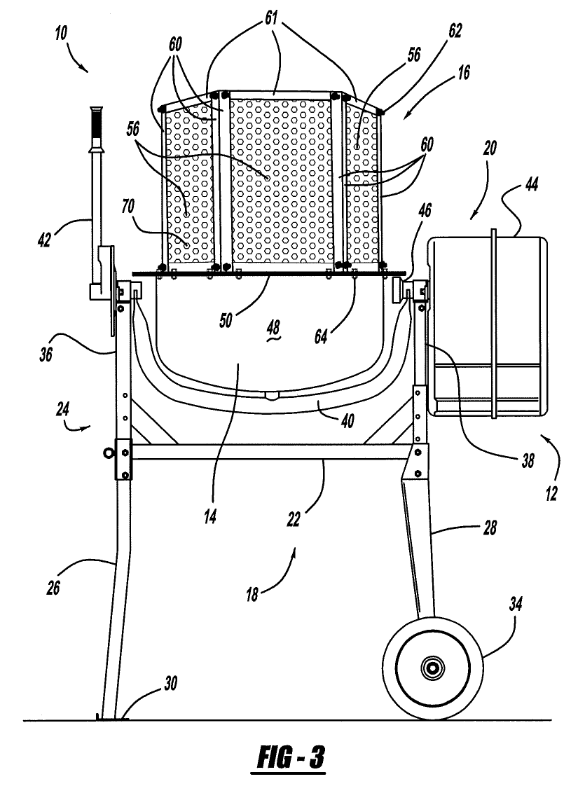

With reference to FIGS. 1-3, a rotary screening device 10 may include a support assembly 12, a bowl 14, and a screen assembly 16. Support assembly 12 may include a frame assembly 18 and a drive mechanism 20. Frame assembly 18 may include a cross member 22 and a bowl support mechanism 24. Cross member 22 may have a first leg 26 coupled to a first end thereof and a second leg 28 coupled to a second end thereof. First leg 26 may include a plate 30 fixed to an end thereof for supporting first end of cross member 22 and having a plurality of apertures 32 therethrough for selectively coupling rotary screening device 10 to a structure (not shown). Second leg 28 may include wheels 34 rotatably coupled to an end thereof, providing portability for rotary screening device 10.

Bowl support mechanism 24 may include first and second arms 36, 38, a bowl support member 40, and a bowl adjustment member 42. First and second arms 36, 38 may extend from cross member 22 and may rotatably support bowl support member 40. Bowl adjustment member 42 may be coupled to first arm 36 and bowl support member 40 to selectively adjust the orientation of bowl support member 40, and therefore bowl 14 relative to support assembly 12.

Drive mechanism 20 may be coupled to frame assembly 18 at second arm 38. Drive mechanism 20 may include a motor 44 and an output shaft 46. Motor 44 may include a gasoline powered engine or an electric motor and may power rotation of output shaft 46. Output shaft 46 may be drivingly engaged with bowl 14 to drive rotation of bowl 14.

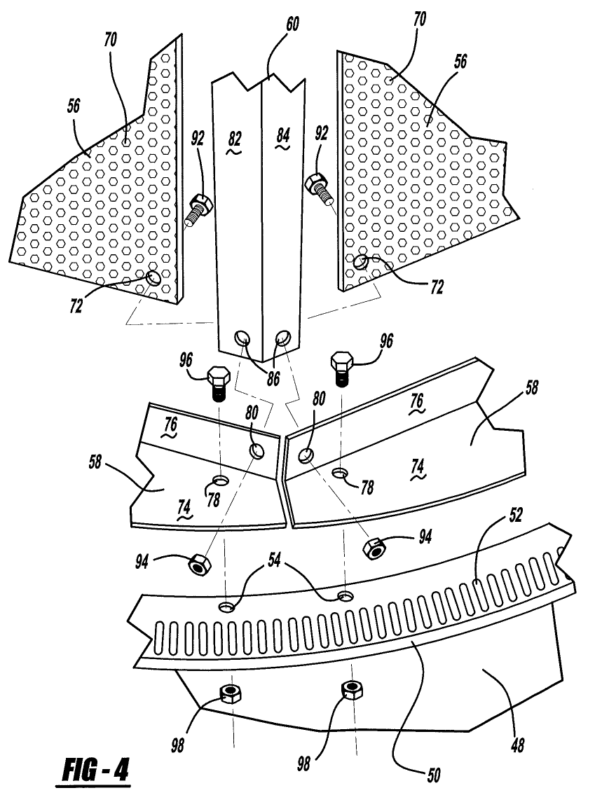

With additional reference to FIG. 4, bowl 14 may include a main body portion 48 having a lip 50 extending circumferentially from an open end thereof. Main body portion 48 may be rotatably supported on bowl support member 40. Lip 50 may include a plurality of slots 52 engaged with output shaft 46 of drive mechanism 20 to provide for powered rotation of bowl 14 by motor 44. Lip 50 may further include a plurality of apertures 54 for mounting screen assembly 16 to bowl 14.

Screen assembly 16 may include screen panels 56, base plates 58, side plates 60, end plates 61, and fastening mechanisms 62, 64. Screen panels 56 may be generally rectangular in shape and may include a variety of screening features such as hexagonal apertures 70. Screen panels 56 may include apertures 72 for coupling screen panels 56 to base and side plates 58, 60.

Base plates 58 may include first and second portions 74, 76. First portion 74 may include a generally planar surface having an arcuate outer perimeter generally corresponding to the outer perimeter of lip 50. First portion 74 may further include apertures 78 extending therethrough and aligned with apertures 54 in lip 50 of bowl 14. Second portion 76 may extend generally perpendicular from an inner edge of first portion 74. Second portion 76 may include apertures 80 aligned with apertures 72 in screen panels 56.

Side plates 60 may include a generally L-shaped cross-section having first and second legs 82, 84. First and second legs 82, 84 may include apertures 86 aligned with apertures 72, 80. Apertures (not shown) at an opposite end of side plates 60 may be similarly aligned with apertures (not shown) at an opposite end of screen panels 56 similar to apertures 72 and apertures (not shown) in end plates 61.

Screen panels 56, base plates 58, side plates 60, and end plates 61 may be coupled to one another and bowl 14 by fastening mechanisms 62, 64. Fastening mechanism 62 may include a bolt 92 and a nut 94. Bolts 92 may pass through apertures 72, 80, 86, as well as apertures (not shown) in opposite ends of screen panels 56 and side plates 60 and apertures (not shown) in end plates 61, and may engage nuts 94 to secure screen panels 56, base plates 58, side plates 60, and end plates 61, to one another, forming a polygonal shaped screen assembly 16. More specifically, screen assembly 16 may have a hexagonal shape. Fastening mechanism 62 may generally provide for removable coupling of screen panels 56, base plates 58, side plates 60, and end plates 61.

Screen assembly 16 may be fixed to bowl 14 for rotation therewith by fastening mechanism 64. Fastening mechanism 64 may include bolts 96 and nuts 98. Bolts 96 may pass through apertures 54, 78 and engage nuts 98 to secure screen assembly 16 to bowl 14. Fastening mechanism 64 may generally provide for removable coupling of screen assembly 16 to bowl 14.

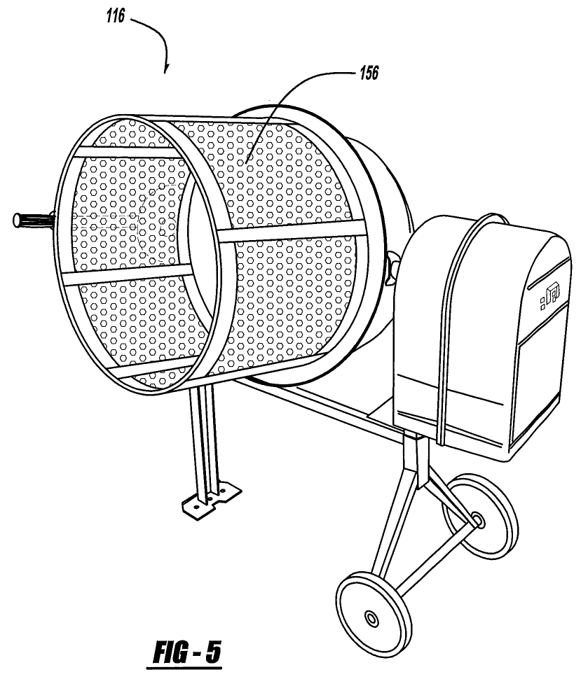

While described above as including a polygonal shape, an alternate screen assembly 116 may be provided as seen FIG. 5. Screen assembly 116 may be generally similar to screen assembly 16, except screen assembly 116 may include a generally circular shape. More specifically, screen panels 156 may be generally arcuate in shape. It is further understood that while described as being formed from a plurality of components, screen assemblies 16, 116 may alternatively be formed as unitary members.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, the specification and the following claims.

What is claimed is:

1. A screening mechanism comprising:
a frame member;
a drive mechanism coupled to said frame member;
a bowl rotatably supported on said frame member and in driven engagement with said drive mechanism; and
a screen assembly fixed to said bowl for rotation therewith, said screen assembly including a plurality of panels removably coupled to one another and removably coupled to said bowl.

2. The screening mechanism of claim 1, wherein said screen assembly includes a plurality of side plates removably coupling said panels to one another.

3. The screening mechanism of claim 2, wherein said screen assembly includes bolts passing through apertures in said panels and said side plates and engaged with nuts to removably secure said panels and said side plates to one another.

4. The screening mechanism of claim 1, wherein said screen assembly includes a plurality of base plates removably coupling said panels to said bowl.

5. The screening mechanism of claim 4, wherein said screen assembly includes a first plurality of bolts passing through a first plurality of apertures in said panels and said base plates and engaged with a first plurality of nuts to removably secure said panels and said base plates to one another.

6. The screening mechanism of claim 5, wherein said screen assembly includes a second plurality of bolts passing through a second plurality of apertures said base plates and engaged with a second plurality of nuts to removably secure said panels to said bowl.

7. The screening mechanism of claim 1, wherein said screen assembly includes a generally polygonal shape.

8. The screening mechanism of claim 7, wherein said polygonal shape is generally hexagonal.

9. The screening mechanism of claim 1, wherein said drive mechanism includes a motor powering rotation of an output shaft drivingly engaged with a lip of said bowl.

10. The screening mechanism of claim 9, wherein said screen assembly is fixed to said lip of said bowl.

11. The screening mechanism of claim 9, wherein said motor is an electric motor.

12. The screening mechanism of claim 9, wherein said motor is a gas motor.

13. The screening mechanism of claim 1, wherein said panels include generally hexagonal apertures to screen a material in said screen assembly.

14. A screening mechanism comprising:
a frame member;
a drive mechanism coupled to said frame member;
a bowl rotatably supported on said frame member and in driven engagement with said drive mechanism; and
a screen assembly fixed to said bowl for rotation therewith, said screen assembly including a plurality of rectangular panels removably coupled to one another to form a generally polygonal shape.

15. The screening mechanism of claim 14, wherein said screen assembly includes a plurality of side plates removably coupling said panels to one another.

16. The screening mechanism of claim 15, wherein said screen assembly includes bolts passing through apertures in said panels and said side plates and engaged with nuts to removably secure said panels and said side plates to one another.

17. The screening mechanism of claim 14, wherein said screen assembly includes a plurality of base plates removably coupling said panels to said bowl.

18. The screening mechanism of claim 17, wherein said screen assembly includes a first plurality of bolts passing through a first plurality of apertures in said panels and said base plates and engaged with a first plurality of nuts to removably secure said panels and said base plates to one another.

19. The screening mechanism of claim 18, wherein said screen assembly includes a second plurality of bolts passing through a second plurality of apertures said base plates and engaged with a second plurality of nuts to removably secure said panels to said bowl.

20. The screening mechanism of claim 14, wherein said drive mechanism includes a motor powering rotation of an output shaft drivingly engaged with a lip of said bowl.
